(19) United States
(12) Patent Application Publication
(10) Pub. No.: US 2009/0009102 A1
(43) Pub. Date: Jan. 8, 2009

(54) LIGHTING DEVICE WITH CONTROLLABLE LIGHT INTENSITY

(75) Inventors: Henricus Marius Joseph Kahlman, Eindhoven (NL); Renatus Willem Clemens Van Der Veeken, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/279,070

(22) PCT Filed: Jan. 31, 2007
(86) PCT No.: PCT/IB2007/050325

§ 371 Date: Aug. 12, 2008

(30) Foreign Application Priority Data
Feb. 14, 2006 (EP) 06101620.0
Dec. 21, 2006 (EP) 06126775.3

(51) Int. Cl. H05B 41/36

(52) U.S. Cl. 315/250

(57) ABSTRACT

It is presented a lighting device comprising: at least one alternating current source configured to provide alternating current of at least a first and a second frequency, at least one light source, at least one impedance unit connected to the light source, affecting a first current from the at least one alternating current source to flow through the at least one light source, wherein an impedance of the impedance unit is configured to be frequency controlled, such that when the alternating current is of the first frequency the first current is relatively high and when the alternating current is of the second frequency the first current is relatively low. A corresponding display device, television device and method are also presented.

### FIELD OF THE INVENTION

The present invention relates to lighting devices, and more particularly to controlling light intensity of light emitting diodes.

### BACKGROUND OF THE INVENTION

Light Emitting Diodes (LED's) can be used for many purposes. One such purpose is to provide backlighting for Liquid Crystal Display (LCD) TVs. With other TV technologies, light is often generated as part of the image rendering. For example in Cathode Ray Tube (CRT) TVs, electrons are shot on a fluorescent screen to render a video image to the user, whereby light is generated in the same process as the video image is rendered. Rendering of images using LCD's in LCD TV's however, does not produce light inherently and requires either reflected light from the room or, more commonly, a light source for the user to be able to view the video image with sufficient light intensity.

In the prior art, it is known to use LED's or fluorescent lamps as backlights for LCD-TV's.

Using LED's in backlights frequently leads to complex, matrix structures with active switches to drive and control these LED's. In particular, when features like scanning, dimming and local highlighting are implemented the topology becomes even more complex. In practice, large areas of printed circuit boards (PCB's) are needed to connect all these devices. This mounts to a problem of large costs that can make the backlight too expensive. Therefore, a solution is required for a simple and inexpensive control of LED's.

Using fluorescent lamps in backlights there is a problem that the backlight requires one inverter (power source) for each fluorescent lamp. As inverters are quite costly, there is a desire to reduce the number of required inverters.

### SUMMARY OF THE INVENTION

In view of the above, an objective of the invention is to solve or at least reduce the problems discussed above.

Generally, the above objectives are achieved by the attached independent patent claims.

A first aspect of the invention is a lighting device comprising: at least one alternating current source configured to provide alternating current of at least a first and a second frequency, at least one light source, at least one impedance unit connected to the light source, affecting a first current from the at least one alternating current source to flow through the at least one light source, wherein an impedance of the impedance unit is configured to be frequency controlled, such that when the alternating current is of the first frequency the first current is relatively high and when the alternating current is of the second frequency the first current is relatively low. This first aspect provides a simple way of controlling light intensity of light sources, which may, for example, form part of a backlight of LCD displays. Costs are reduced compared to prior art solutions for light intensity controls, which are complex and/or expensive.

The lighting device may comprise a first light emitting diode string comprising at least one light source comprising a light emitting diode arranged to allow a first current to flow in a first direction, and a second light emitting diode string comprising at least one light source comprising a light emitting diode arranged to allow a second current to flow in a second direction, the second direction differing from the first direction. With two LED strings, current can flow in both directions in the LED device, allowing for a simpler assembly.

The first light emitting diode string may be connected in parallel with the impedance unit, and the second light emitting diode string may be connected in parallel with the impedance unit. A parallel arrangement allows the use of only one impedance unit to control light intensity for an entire LED device.

The lighting device may comprise a plurality of light emitting diode devices, wherein each of the light emitting diode devices comprises at least one light source and at least one impedance unit, the light emitting diode devices being connected in series forming a light emitting diode device strip, wherein the light emitting diode strip may be connected to at least one of the at least one alternating current source. A series of LED devices may advantageously be connected in series, allowing for efficient production and simple assembly into an environment where the lighting device will be used.

A plurality of the light emitting diode device strips may be connected in parallel. With a plurality of LED device strips connected in parallel, a single current source may drive all LED device strips.

The impedance of the impedance unit of all light emitting diode devices may be the same within a fault tolerance for any frequency which can be generated by the alternating current source, and one alternating current source may be arranged to provide alternating current to all of the light emitting diode device strips. Having the same impedance (within a fault tolerance) for all impedance units for any frequency, all LED devices can be controlled simultaneously and will behave similarly. Moreover, having the same specifications for all LED devices will make production simpler and more economical.

The impedance may differ between impedance units of light emitting diode devices within each light emitting diode strip, and one alternating current source may be arranged to provide alternating current to all of the light emitting diode device strips. With differing impedances, individual control may be achieved by means of shifting the frequency.

The impedance may differ between impedance units of light emitting diode devices within each light emitting diode strip, and one alternating current source may be arranged to provide alternating current to each the light emitting diode device strip. Having a current source for each strip provides a refined control over light intensity in each LED device.

In each of the plurality of light emitting diode strips, the impedance units of light emitting diode devices in corresponding positions of each strip may have the same impedances within a fault tolerance for any frequency which can be generated by the alternating current source. By dimensioning impedance units in corresponding positions to have the same impedance at any frequency, the light intensity of corresponding LED devices may be controlled simultaneously. If the LED strips are aligned in parallel, this allows a scanning effect to be produced with ease.

The light emitting diode device strip may be implemented on a printed circuit board. Using a PCB simplifies production and makes it economical.

Each of the at least one light sources may be a fluorescent lamp. Fluorescent lamps also benefit from more efficient control, reducing the number of inverters required.

The lighting device may comprise a plurality of multi-lamp drivers, wherein each multi-lamp driver may comprise an alternating power source, a plurality of impedance units, the multi-lamp driver may be configured to provide power to a plurality of fluorescent lamps.

The impedance unit may comprise a first capacitor connected in parallel to an inductor. This is a simple circuit which allows for frequency controlled impedance.

The impedance unit may further comprise a second capacitor connected serially with the inductor. Connecting this second capacitor prevents direct current to flow through the impedance unit.

The lighting device may be in the form of a backlight for a liquid crystal display television. It is very useful to be able to control backlight, while still being able to produce this backlight with good economy.

A second aspect of the invention is a display device comprising a liquid crystal display and a lighting device according to the first aspect of the invention.

A third aspect of the invention is a television device comprising a display device according to the second aspect of the invention.

A fourth aspect of the invention is a method for controlling light intensity of a lighting device, the method comprising the steps of: arranging at least one alternating current source configured to provide alternating current of at least a first and a second frequency, connecting at least one light source, connecting at least one impedance unit connected to the light source, affecting a first current from the at least one alternating current source to flow through the at least one light source, controlling an impedance of the impedance unit using frequency control, such that when the alternating current is of the first frequency the first current is relatively high and when the alternating current is of the second frequency the first current is relatively low.

Other objectives, features and advantages of the present invention will appear from the following detailed disclosure, from the attached dependent claims as well as from the drawings.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of the element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

Embodiments of the present invention will now be de-scribed in more detail, reference being made to the enclosed drawings, in which:

FIG. 1 shows an exemplary impedance unit according to an embodiment of the present invention.

FIG. 2 shows a LED unit with an associated control unit according to an embodiment of the present invention.

FIG. 3 is a diagram of how current through LED's are affected by frequency in the LED unit shown in FIG. 2.

FIGS. 4a and 4b show two different arrangements of LED units such as the LED unit of FIG. 2.

FIG. 5 shows two LED units arranged to allow DC controlled color shifts according to an embodiment of the present invention.

FIGS. 6A and 6B show embodiments of the present invention using fluorescent lamps.

### DETAILED DESCRIPTION OF EMBODIMENTS

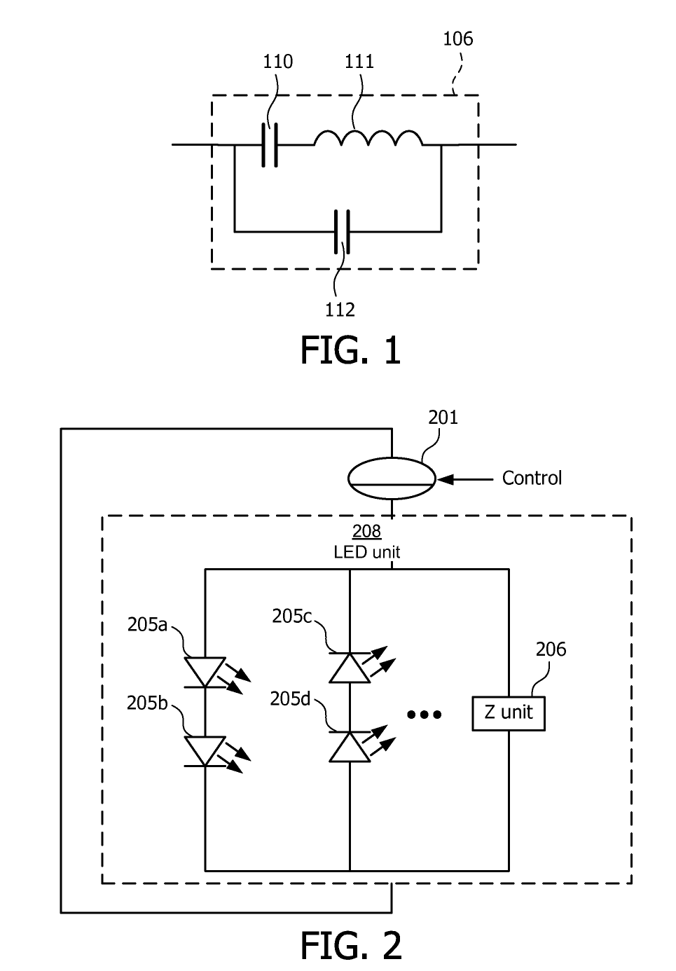

FIG. 1 shows an exemplary impedance unit 106 according to an embodiment of the present invention. The impedance unit 106 consists of a first capacitor 112 and an inductor 111 connected in parallel. Optionally, a second capacitor 110 is connected serially to the inductor 111 to block DC current through the impedance unit 106. As is known in the art per se, when the impedance unit 106 is connected to an alternating current (AC), the impedance of the circuit varies as a function of the frequency of the alternating current. With a circuit such as the one shown here, the impedance unit has a particular frequency where its impedance reaches a peak, which frequency is called the resonance frequency, or the high impedance frequency of the impedance unit. The resonance frequency depends on the capacitances and inductances of the capacitors 110, 112 and the inductor 111. Although a simple LC-circuit is shown here, it is a mere example to allow a man skilled in the art to implement or use the invention. Consequently, the invention is not limited to an impedance unit of this type and may be any type of circuit with a frequency controlled impedance.

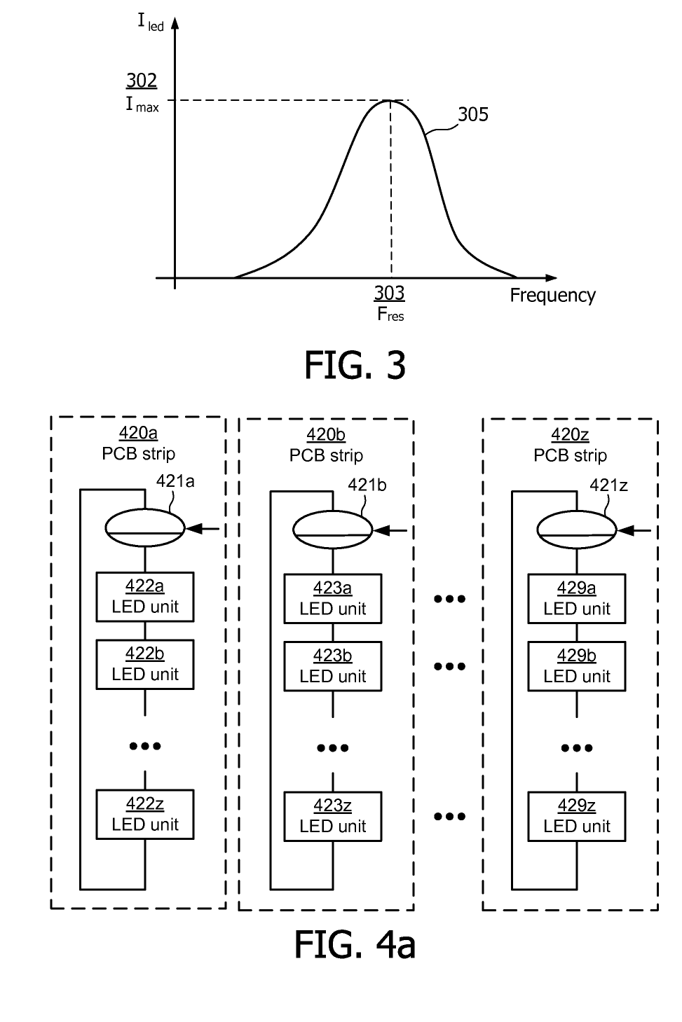

With reference to FIG. 2, an impedance unit 206, such as the impedance unit 106 of FIG. 1, is connected in parallel with at least two LED strings. A first LED string, made up of LED's 205a and 205b, emit light when a current flows downwards and blocks current when it flows upwards. On the other hand, LED's 205c and 205d, of a second LED string, are arranged in the opposite direction, emitting light when the current flows upwards and blocks downward current. The LED's 205a-d, connected to the impedance unit 206 make up an LED unit 208. Control unit 201 is a source of an alternating current (AC), or alternating voltage, and controls frequency, amplitude and DC offset of this alternating current through the LED unit 208. With further reference to FIG. 3, when the frequency of the current is close to a resonance frequency of the impedance unit 206, Fᵣₑₛ, the impedance of the impedance unit 206 is relatively high. The current then flows relatively easy through the LED's 205a-d, leading to a relatively higher current. As can be seen in FIG. 3, the current peaks at the frequency Fᵣₑₛ 303, where Fᵣₑₛ is the resonance frequency of the impedance unit 206, with a value of Iₘₐₓ 302. In other words, the LED's have their strongest light intensity when the frequency of the AC is Fᵣₑₛ. Thus, by controlling the frequency of the alternating current, the light intensity of the LED unit 208 is controlled, using only simple and inexpensive components. Although not shown in FIG. 2, there may be one impedance unit for each LED string, where each impedance unit is connected in series with each LED string.

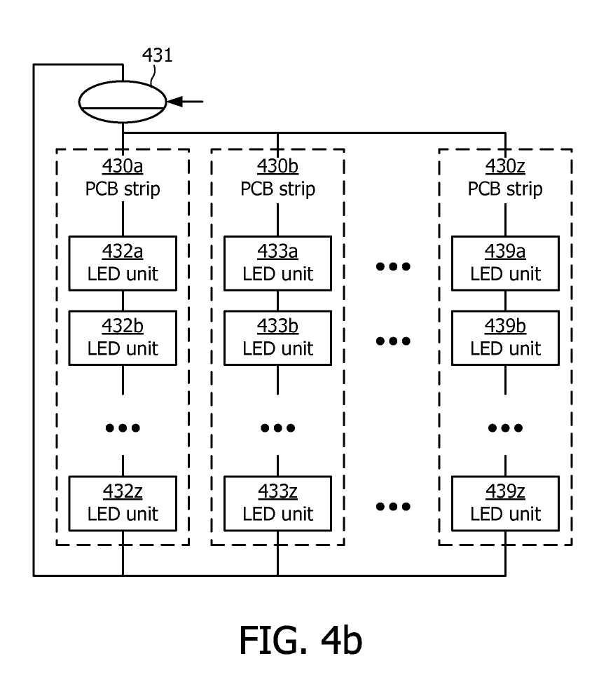

As can be seen in FIG. 4a, a plurality of LED units 422a, 422b, . . . , 422z are connected serially with a control unit 421a. These components together may all be combined on a Printed Circuit Board (PCB) strip 420a. Correspondingly, a second PCB strip 420b comprises a control unit 421b and LED units 423a, 423b, . . . , 423z. An arbitrary number of PCB strips, including 420z, comprising a control unit 421z and LED units 429a, 429b, . . . , 429z, may thus be combined to form a backlight for a LCD TV. The PCB strips may be arranged horizontally, vertically, radially, diagonally or in any other suitable fashion. It is to be noted that each PCB strip can house an arbitrary number of LED units.

If the resonance frequencies of each LED unit in each PCB strip are configured to differ from each other, a matrix is effectively created, allowing two-dimensional control over light intensity. The light intensity of an entire PCB strip is effected by the amplitude of the AC for the PCB strip in question. The band-pass characteristics of the LED units in a strip may optionally overlap to suit a particular light output demands for the backlight. For instance, this may be needed in case a smooth transition from one zone to another is needed.

FIG. 4b shows a simplified arrangement for only dimming and scanning. Here only one control unit is required, thus reducing cost. A first PCB strip 430a then comprises LED units 432a, 432b, . . . , 432z. A second PCB strip 430b comprises LED units 433a, 433b, . . . , 433z, while a last PCB strip 430z of an arbitrary number of PCB strips, comprises LED units 439a, 439b, . . . , 439z. With this arrangement, one control unit 431 provides a current for all PCB strips, whereby the current cannot be controlled for an individual strip. On the other hand, by controlling the frequency of the current, light intensity can be controlled for different LED units within each light strip. In one embodiment, the resonance frequencies of LED units in the same position of each strip are chosen to be the same (within a given fault tolerance, such as 1, 5 or 10%). For example, 432a, 433a and 439a are chosen to have the same resonance frequency, 432b, 433b and 439b are chosen to have the same resonance frequency, etc. This allows simultaneous control over corresponding LED units, leading to an ability to perform effects such as scanning (horizontal line of light). Additionally, by changing the amplitude of the current, light intensity for all LED units are affected simultaneously, in other words dimming of all LED units. In another embodiment, all LED units are chosen to have the same resonance frequency. While this configuration allows less control, it may be a configuration which is more cost effective to produce. Although the PCB strips in FIG. 4b are connected in parallel, another possible configuration is cascading the PCB strips, or a combination of cascade and parallel connections.

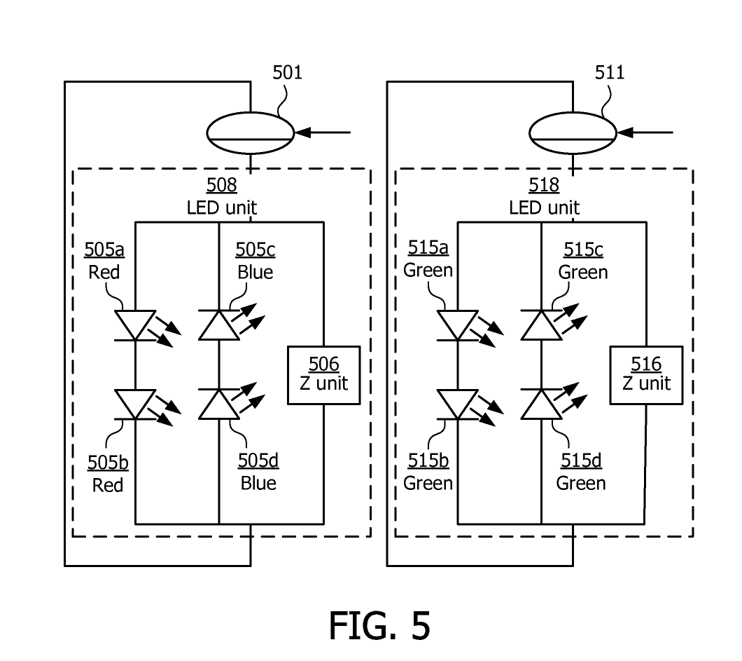

Hitherto it has only been mentioned that the control unit can control amplitude and frequency of the alternating current it produces. With the addition of direct current (DC) shift, the control unit can also control color balance. FIG. 5 shows a first and a second LED unit 508, 518, connected to a first and second control unit 501/511, respectively, and having a first and a second impedance unit 506/516, respectively. The first LED unit 508 has red LED's 505a, 505b in one current direction and blue LED's 505c, 505d in an opposite current direction. The second LED unit has only green LED's 515a-d. If the first control unit applies a DC shift downwards, the red LED's will produce slightly more light intensity. Correspondingly, a DC shift in the opposite direction will produce more blue light. For the second LED unit 518, any shift in DC from zero will result in an increased intensity of green. Accordingly, color balance can be controlled efficiently by means of a DC shift of these two LED units. As is easily realized by a man skilled in the art, other the configuration of the colored LED's can be adjusted, while still providing a DC controllable color balance. For example, LED's with the colors red, green, blue and white may be used, or other colors may be used, such as including amber color in the configuration.

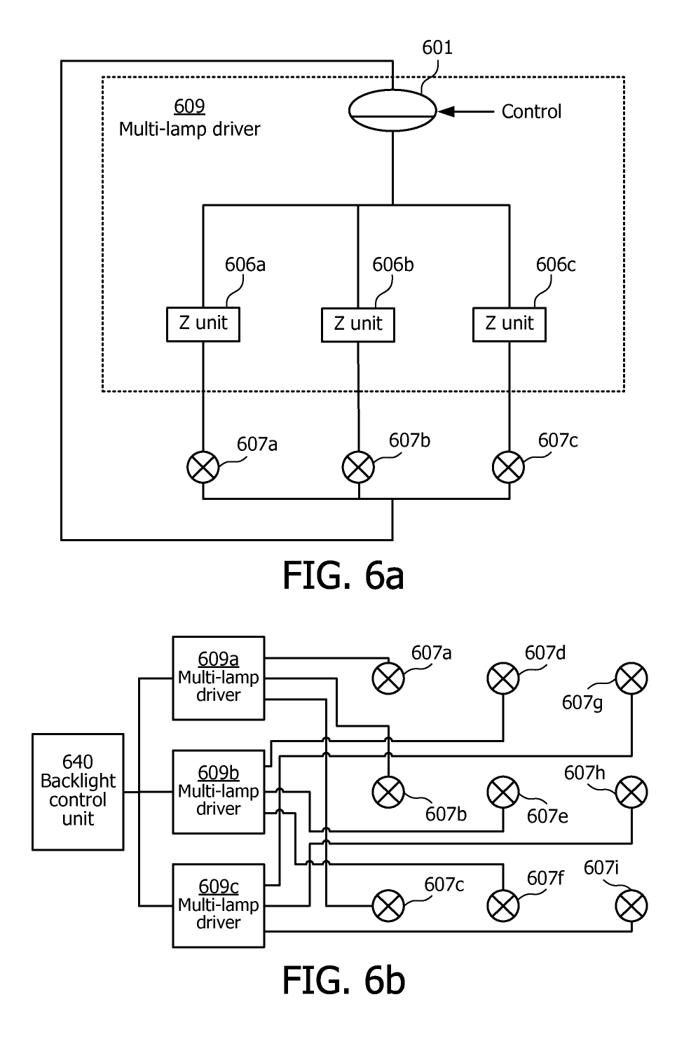

FIG. 6a shows an embodiment in which the invention is used in conjunction with fluorescent lamps. While fluorescent lamps are used in this example, any light source supporting bi-directional current can be used, such as light bulbs. Control unit 601, also known as an inverter, is a source of an alternating current or alternating voltage. In this embodiment, there are three impedance units 606a-c, such as impedance unit 106 of FIG. 1, whose impedance depends on the frequency of the voltage provided, as explained in conjunction with FIG. 3 above. The control unit 601 and the impedance units 606a-c are part of a multi-lamp driver 609. As the name implies, the multi-lamp driver is capable of driving a number of lamps, in this example three lamps 607a-c, whose light intensity depends on the impedance of the respective connected impedance unit 606a-c, which in turn then depends on the frequency of the voltage from the control unit 601. It is thus possible to design a multi-lamp driver 609 with appropriate frequency characteristics to drive the connected fluorescent lamps 607a-c, in a similar fashion to what is described above in conjunction with LEDs. It is to be noted that any number of lights is within scope of the present invention. In a situation where a duty cycle of the lamps 607a-c is about 33% or less, an arrangement such as the one shown in FIG. 6a only needs one inverter 601 to drive all three lamps. In a traditional arrangement, each lamp is connected to a separate inverter. Consequently, the arrangement shown in FIG. 6a reduces the need of inverters to one third compared to a traditional arrangement, reducing cost and availability.

FIG. 6b shows an embodiment where a plurality of multi-lamp drivers 609a-c are employed. In this example, each multi-lamp driver 609a-c drives three lamps. Multi-lamp driver 609a drives lamps 607a-c; multi-lamp driver 609b driver lamps 607d-f and multi-lamp driver 609c driver lamps 607g-i. Note that for reasons of clarity, the full electrical circuit is not illustrated here. All multi-lamp drivers 609a-c are controlled by backlight control unit 640. The backlight control unit 640 can also use vertical synchronization, optical feedback from the backlight and/or temperature feedback from the backlight as input to consider. The output from backlight control unit 640 is frequency control provided to the multi-lamp drivers. The layout of the lamps 607a-i is such that each row has lamps from each of the multi-lamp drivers 609a-c. For example, in the first row of lamps, lamp 607a is connected to multi-lamp-driver 609a; lamp 607d is connected to multi-lamp-driver 609b and lamp 607g is connected to multi-lamp-driver 609c.

The invention has mainly been described above with reference to a few embodiments. However, as is readily appreciated by a person skilled in the art, other embodiments than the ones disclosed above are equally possible within the scope of the invention, as defined by the appended patent claims.

1. A lighting device comprising:
at least one alternating current source (201, 420a-z, 430l-z, 501, 511, 601) configured to provide alternating current of at least a first and a second frequency,
at least one light source,
at least one impedance unit (106, 206, 606a-c) connected to said light source, affecting a first current from said at least one alternating current source to flow through said at least one light source,
wherein an impedance of said impedance unit (106, 206, 606a-c) is configured to be frequency controlled, such that when said alternating current is of said first frequency said first current is relatively high and when said alternating current is of said second frequency said first current is relatively low.

2. The lighting device according to claim 1, wherein said lighting device comprises a first light emitting diode string comprising at least one light source comprising a light emitting diode (205c-d) arranged to allow a first current to flow in a first direction, and a second light emitting diode string comprising at least one light source comprising a light emitting diode (205c-d) arranged to allow a second current to flow in a second direction, said second direction differing from said first direction.

3. The lighting device according to claim 2, wherein said first light emitting diode string is connected in parallel with said impedance unit (106, 206), and said second light emitting diode string is connected in parallel with said impedance unit (106, 206).

4. The lighting device according to claim 2, comprising a plurality of light emitting diode devices (208, 422a-z, 423a-z, 429a-z, 432a-z, 433a-z, 439a-z, 508, 518), wherein each of said light emitting diode devices comprises at least one light source and at least one impedance unit, said light emitting diode devices being connected in series forming a light emitting diode device strip (420a-z, 430a-z), wherein said light emitting diode strip (420a-z, 430a-z) is connected to at least one of said at least one alternating current source (201, 420a-z, 430l-z, 501, 511).

5. The lighting device according to claim 4, wherein a plurality of said light emitting diode device strips (420a-z, 430a-z) are connected in parallel.

6. The lighting device according to claim 4, wherein the impedance of the impedance unit (106, 206) of all light emitting diode devices (208, 422a-z, 423a-z, 429a-z, 432a-z, 433a-z, 439a-z, 508, 518) is the same within a fault tolerance for any frequency which can be generated by said alternating current source (201, 420a-z, 430l-z, 501, 511), and one alternating current source (201, 420a-z, 430l-z, 501, 511) is arranged to provide alternating current to all of said light emitting diode device strips (420a-z, 430a-z).

7. The lighting device according to claim 4, wherein the impedance differs between impedance units (106, 206) of light emitting diode devices (208, 422a-z, 423a-z, 429a-z, 432a-z, 433a-z, 439a-z, 508, 518) within each light emitting diode strip (420a-z, 430a-z), and one alternating current source (201, 420a-z, 430l-z, 501, 511) is arranged to provide alternating current to all of said light emitting diode device strips (420a-z, 430a-z).

8. The lighting device according to claim 4, wherein the impedance differs between impedance units (106, 206) of light emitting diode devices (208, 422a-z, 423a-z, 429a-z, 432a-z, 433a-z, 439a-z, 508, 518) within each light emitting diode strip (420a-z, 430a-z), and one alternating current source (201, 420a-z, 430l-z, 501, 511) is arranged to provide alternating current to each said light emitting diode device strip (420a-z, 430a-z).

9. The lighting device according to claim 4, wherein in each of said plurality of light emitting diode strips (420a-z, 430a-z), the impedance units (106, 206) of light emitting diode devices (208, 422a-z, 423a-z, 429a-z, 432a-z, 433a-z, 439a-z, 508, 518) in corresponding positions of each strip (420a-z, 430a-z) have the same impedances within a fault tolerance for any frequency which can be generated by said alternating current source (201, 420a-z, 430l-z, 501, 511).

10. The lighting device according to claim 4, wherein said light emitting diode device strip (420a-z, 430a-z) is implemented on a printed circuit board.

11. The lighting device according to claim 1, wherein each of said at least one light sources is a fluorescent lamp (607a-c).

12. The lighting device according to claim 11, comprising a plurality of multi-lamp drivers, wherein each multi-lamp driver comprises an alternating power source (601), a plurality of impedance units (606a-c), said multi-lamp driver is configured to provide power to a plurality of fluorescent lamps (607a-c).

13. The lighting device according to claim 1, wherein said impedance unit (106, 206, 606a-c) comprises a first capacitor (112) connected in parallel to an inductor (111).

14. The lighting device according to claim 13, wherein said impedance unit (106, 206, 606a-c) further comprises a second capacitor (110) connected serially with said inductor (111).

15. The lighting device according to claim 1, in the form of a backlight for a liquid crystal display television.

16. A display device comprising a liquid crystal display and a lighting device according to claim 1.

17. A television device comprising a display device according to claim 16.

18. A method for controlling light intensity of a lighting device, said method comprising the steps of:
arranging at least one alternating current source (201, 420a-z, 430l-z, 501, 511, 601) configured to provide alternating current of at least a first and a second frequency,
connecting at least one light source,
connecting at least one impedance unit (106, 206, 606a-c) connected to said light source, affecting a first current from said at least one alternating current source to flow through said at least one light source,
controlling an impedance of said impedance unit (106, 206, 606a-c) using frequency control, such that when said alternating current is of said first frequency said first current is relatively high and when said alternating current is of said second frequency said first current is relatively low.
